(19) United States
(12) Patent Application Publication
(10) Pub. No.: US 2008/0165972 A1
(43) Pub. Date: Jul. 10, 2008

(54) METHOD AND SYSTEM FOR ENCRYPTED EMAIL COMMUNICATION

(75) Inventor: Cristian Alfred Worthington, Vancouver (CA)

Correspondence Address: OYEN, WIGGS, GREEN & MUTALA LLP;480 - THE STATION, 601 WEST CORDOVA STREET, VANCOUVER, BC, V6B 1G1, omitted

(73) Assignee: i-fax.com Inc., Vancouver (CA)

(21) Appl. No.: 11/621,080

(22) Filed: Jan. 8, 2007

(51) Int. Cl. H04L 9/08

(52) U.S. Cl. 380/278

(57) ABSTRACT

An email encryption method and system in which a sender generates an encryption key, which is sent to a key server along with a message key and the recipient's user identification, the sender encrypts the email message, sends the encrypted message and message key to a recipient, and the encryption key is released by the key server to a registered recipient upon receipt of the registered recipient's user identification and the message key.

### TECHNICAL FIELD

The present invention relates to electronic mail (“email”) systems and more particularly to methods of encrypting email communications.

### BACKGROUND

Email communication is largely conducted across unsecured networks and the Internet, using the Simple Mail Transfer Protocol (“SMTP”). Email users can currently use one of three primary methods to send an encrypted email using SMTP:

i) Transport Layer Security (TLS) allows users to send encrypted emails, as long as both users have email accounts on email servers that support the TLS protocol.

ii) Asymmetrical Cryptography or Public Key Encryption, such as PGP and RSA encryption, allows a sender to encrypt an email message prior to sending the email with the sender's private key combined with the recipient's public key. Recipients can decrypt the message with the sender's public key and their own private key.

iii) Symmetrical Cryptography, such as “one time pad” encryption, allows users to encrypt a message prior to sending the email using a prearranged key that is shared by the sender and the recipient.

The foregoing three methods of encrypting email transmissions commonly in use today have a number of problems. With respect to TLS encryption of emails, TLS is not universally used and most email users do not know if they are connected to an email server that supports TLS. So if the sender is attached to an email server that supports TLS encryption, he/she has no guarantee that the intended recipient is also connected to a TLS compatible server. While it is possible to configure an email server to refuse to connect to another server that does not support TLS, very few email service providers use this feature as it would result in many emails failing to be delivered. Also, as its name implies, TLS only encrypts the email while it is in transmission (during “transport” between email servers). The email is not encrypted while it sits on the recipient's server waiting to be read by the recipient.

With regard to the use of Asymmetrical Cryptography for encrypting emails, most email users are not familiar with Asymmetrical Cryptography and they are not equipped with the means to decrypt emails that are sent to them in an encrypted format. The sender must first obtain the recipient's public key from the intended recipient, before encrypting and sending the email. This means that users must engage in a key exchange process before an email can be sent, making it impossible for the sender to send an email before a key exchange has taken place. The recipient must obtain the sender's public key prior to decrypting and reading the email. This type of encryption therefore requires two key exchanges, whereby public keys must be shared bidirectionally between the sender and recipient. In the event that two users (a sender and a recipient) exchange public keys, the users would then need to agree to continue to use the same keys (static key) for subsequent emails. Static keys are less secure, since, by keeping the keys constant for subsequent emails, a hacker has a better chance of breaking the keys.

Further, Asymmetrical Cryptography is not useful for sending an email to a broadcast list of recipients, since the method requires the sender to: a) bidirectionally exchange public keys with every recipient; and b) encrypt the message differently for each intended recipient, as each recipient will have a different public key. For example, if a user named Bob wishes to send encrypted emails to two users named Alice and John, Bob must share public keys with Alice and John in two separate key exchanges. Having exchanged keys with Bob, Alice and John are still not able to communicate with each other, until Alice and John also exchange keys. As groups of users grow in number, the number of bidirectional pathways between users jumps exponentially, requiring each pair of users to exchange public keys.

With regard to the use of Symmetrical Cryptography when encrypting emails, similarly most email users are not familiar with Symmetrical Cryptography and they are not equipped with the means to decrypt emails that are sent to them in an encrypted format. The sender and the recipient must share the encryption key or “pad” before the recipient can decrypt and read the email. This is often referred to as “shared secret” encryption. Senders can choose to vary the key each time a message is encrypted (static key) or vary the key each time a message is sent (dynamic keys). Static keys are less secure, as a hacker can read all the messages sent with a given static key when he/she discovers the key once. Additionally, the repeated use of the same key makes efforts to discover the key technically easier. Dynamic keys, where “one time pads” are used, are very secure and are considered the most unbreakable form of encryption. But one time pads require senders and recipients to exchange keys every time a message is sent.

If a sender wishes to have secure communication with multiple recipients using Symmetrical Cryptography, the sender must either: a) use different keys for each recipient, causing a logistically complex arrangement in which each pair of sender/recipient must share a different key or “secret”; or b) use the same key for an entire group of recipients, requiring all of the recipients to receive the new key before decrypting and reading the message.

There is therefore a need for an email encryption system that will permit sending parties to forward single or broadcast encrypted emails without first exchanging keys with each recipient or knowing the decryption capability of each recipient. Further there is a need for an email encryption system that allows recipients of encrypted emails to receive and decrypt encrypted emails without exchanging keys in advance of the communication with the sender.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention provides an email encryption method and system in which the sender generates the encryption key, which is sent to a key server along with a message key, the sender encrypts the email message, sends the encrypted message and message key to a recipient, and the encryption key is released by the key server to a registered recipient upon receipt of the registered recipient's email address and the message key.

The present invention allows an email sender to encrypt an email using a dynamically assigned symmetrical encryption key (a one time pad), send the email to a recipient who may or may not be a prior user of the system, allows the recipient to easily retrieve the Encryption Key (one time pad) after the message has been encrypted and sent, thus not requiring prior communication with the sender, and provides a process that allows the authorized recipient to easily decrypt the email.

The invention comprises a sender's client computer, a recipient's client computer, a secure computer server called a Key Control Server and a key control process. According to the method of the invention, a user of the system (email senders and recipients) can register to use the system by receiving a registration key that corresponds to a unique user identifier such as the user's email address. An email sender's client computer generates an encryption key and a message key as an email is being sent, encrypts the content of the email using the encryption key, and sends the encryption key, the message key and the recipient's email address to the Key Control Server, and then sends the encrypted email containing the message key to the email address of the intended email recipient. An email recipient's client computer contains a registration key corresponding to the recipient's unique user identification, such as the recipient's email address. The recipient receives the encrypted email containing the message key, sends its registration key and the message key to the Key Control Server and receives back from the Key Control Server the encryption key corresponding to the message, permitting the recipient to decrypt the message.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating computer network as used in the invention.

FIG. 2 illustrates two tables or databases used by the Key Control Server according to the invention.

FIG. 3 is a flow chart illustrating the method of registering a client who sends an encrypted email for the first time according to the invention.

FIG. 4 is a flow chart illustrating the method of registering a client who receives an encrypted email for the first time according to the invention.

FIG. 5 is a flow chart illustrating the method by which the Key Control Server 16 relays the Encryption Key from the sender 10 to the recipient.

FIG. 6 is a flow chart illustrating the method of sending an encrypted email by a registered sender according to the invention.

FIG. 7 is a flow chart illustrating the method of receiving and decrypting an encrypted email by a registered recipient according to the invention.

FIG. 8 is a schematic diagram illustrating the general method as used in the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

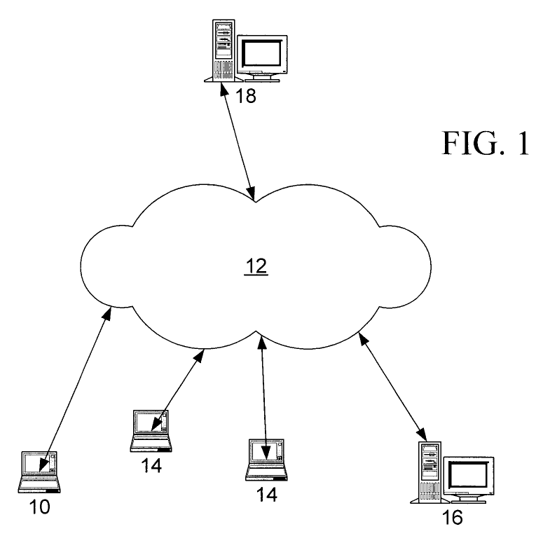

With reference to FIG. 1, a sender's client computer (“sender”) 10 communicates over a network 12, such as the Internet or other wide area or local area network, with a recipient's client computer (“recipient”) 14 and a secure computer server 16 which is referred to hereinafter as the Key Control Server 16. Client computers 10, 14 and server 16 are provided with central processors, data storage and email communications software, for example conventional email client software such as Microsoft Outlook, Netscape Mail or Thunderbird, which permits client computers 10, 14 and server 16 to send and receive email communications over the Internet or other network using email servers in a conventional way. Client computers 10, 14 may be laptops, desktops, handheld, personal digital assistants, mobile telephones or any other devices capable of communicating over a network.

The present invention is implemented by server software implemented on the Key Control Server and by providing email client software to the senders 10 and recipients 14 which may be done preferably over the Internet by means of downloads from a registration website 18, or by purchasing or delivering physical copies of the software. Registration website 18 may be maintained by the Key Control Server 16 or may be maintained by separate web page servers which are in secure communication with the Key Control Server 16. The email client software can be installed on any conventional email client, such as Microsoft Outlook, Netscape Mail or Thunderbird. The software can also be installed on the client's web browser, such as Internet Explorer or Firefox, as a plug-in that allows the user to encrypt emails sent on “web mail” products, such as Hotmail, Yahoo Mail and gMail.

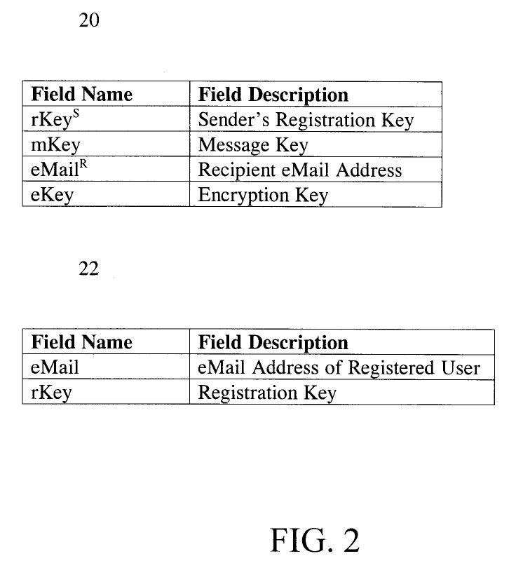

FIG. 2 illustrates two tables or databases 20, 22 used by the Key Control Server 16 when exchanging the Encryption Key (eKey). Sent Message Table 20 contains the data produced by the sender client software prior to, during or after the transmission of the email to the recipient 10. This table contains the following fields:

| Field Name | Field Description |
|---|---|
| rKey^{S} | Sender's Registration Key |
| mKey | Message Key |
| eMail^{R} | Recipient eMail Address |
| eKey | Encryption Key |

Sender's Registration Key (rKey^{S})—This is a unique key generated by the Key Control Server which may be used by the system to identify the sender.

Message Key (mKey)—This is a unique identifier generated by the Sender Client Software that identifies a specific message.

Recipient Email Address (eMail^{R})—The email address of the recipient is used to compare to the Recipient's Registration Key (rKey^{R}).

Encryption Key—The Encryption Key (eKey) is the encryption key used by the Sender Client Software to encrypt the email.

Further with reference to FIG. 2, the Registration Table 22 contains the data generated during the registration process, when senders 10 and recipients 14 register to use the system. This Table contains the following fields:

| Field Name | Field Description |
|---|---|
| eMail | eMail Address of Registered User |
| rKey | Registration Key |

Email Address (eMail)—The email address of a registered User.

Registration Key (rKey)—A value that is assigned by the Key Control Server at the time the user registers to use the system. This value is unique to the specific user and is directly associated with the user's Email Address.

According to the method of the invention, a user of the system can send or receive encrypted emails. In each instance there is a sender 10 and a recipient 14 of the email, both of whom must have access to the Key Control Server and the system client software. The recipient must be registered with the system. A user of the system (email senders 10 and recipients 14) can register to use the system by receiving a registration key that corresponds to a unique user identification such as the user's email address. An email sender's client computer 10 generates an Encryption Key and a Message Key as an email communication is being prepared, encrypts the content of the email using the Encryption Key, then sends the Encryption Key, the Message Key, and optionally the recipient's email address, to the secure Key Control Server and then sends the encrypted email containing the Message Key to the email address of the intended email recipient. An email recipient's client computer 14 contains a Registration Key corresponding to the email address associated with the recipient's email address that can receive the encrypted email containing the Message Key, send the Registration Key and Message Key to the Key Control Server and receive the Encryption Key corresponding to the message and decrypt the message.

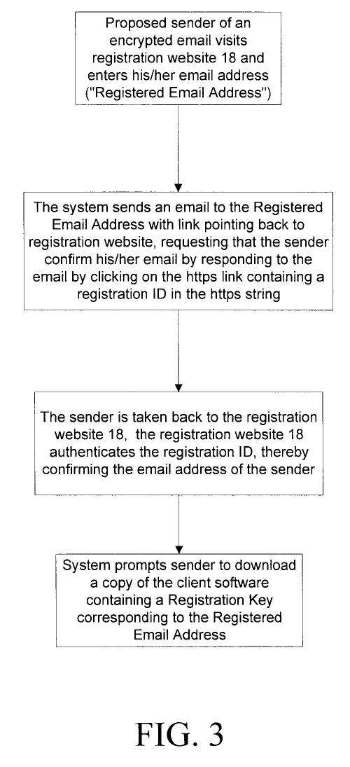

FIG. 3 illustrates the process for registering a client who sends an encrypted email for the first time. In the event that a sender 10 does not have a copy of the required email client software, the sender 10 will visit the registration website 18 and download a copy of the software. Optionally the system can also provide the sender a Registration Key associated with a unique user identification such as the sender's email address. The registration process involves the following steps. First the sender 10 of the encrypted email visits registration website 18 that allows the sender to enter his/her email address, referred to as the Registered Email Address. The system then sends an email to the Registered Email Address containing an https link pointing back to the registration website and containing a registration ID in the https string. The email requests that the sender 10 confirm his/her email by responding to the email by clicking on the https link containing the registration ID in the https string. The sender 10 is taken back to the registration website 18. The registration website 18 authenticates the registration ID, confirming the email address of the sender 10. If the email is confirmed, the system then allows the user to download a copy of the client software containing a Registration Key corresponding to the sender's email address. The sender 10 has then successfully downloaded the software and has a Registration Key resident on his/her computer that will entitle the user to send encrypted emails using the software.

While it is necessary for the sender to download the client software, the system need not identify the sender by a Registration Key to function. However there are some benefits of providing the sender with a Registration Key upon obtaining the system software. By obtaining a Registration Key the sender will also be able to use the system as a recipient. Further, the Registration Key may also be used to prove the identity of the sender to verify to the recipient that the sender is legitimate and not spam or a virus, or be used in connection with other features of the system.

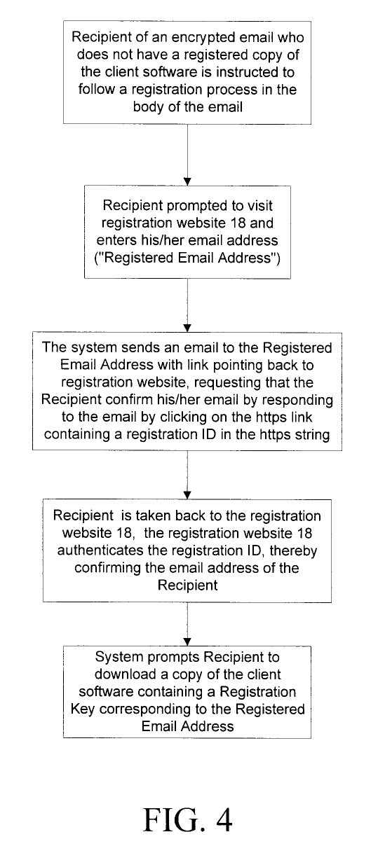

FIG. 4 illustrates the process for registering a client recipient 14 who receives an encrypted email for the first time. In the event that a recipient 14 of an encrypted email does not have a registered copy of the client software, the recipient is instructed to follow a registration process in the body of the email. When the recipient has registered and received a copy of the software, the recipient 14 will be able to follow the steps outlined below to receive and decrypt the encrypted mail. The registration process involves the following steps. First the recipient 14 receives an encrypted email. The recipient of the encrypted email is prompted to receive a registered copy of the software by clicking on an https link in the email body. The recipient is taken to the registration website 18 that allows the recipient to enter his/her email address as the Registered Email Address. The system then sends an email to the Registered Email Address requesting that the recipient 14 confirm his/her email by responding to the email by clicking on an https link containing a registration ID in the https string. The recipient is then taken back to the registration website 18. The registration website authenticates the registration ID, confirming the email address of the recipient. If the email is confirmed, the system then allows the user to download a copy of the Receiver Client Software containing a Registration Key associated with a unique user identification such as the recipient's email address. The recipient 14 will then have successfully downloaded the software and will have a Registration Key resident on his/her computer that will entitle the user to receive Encryption Keys directed to the user's email address.

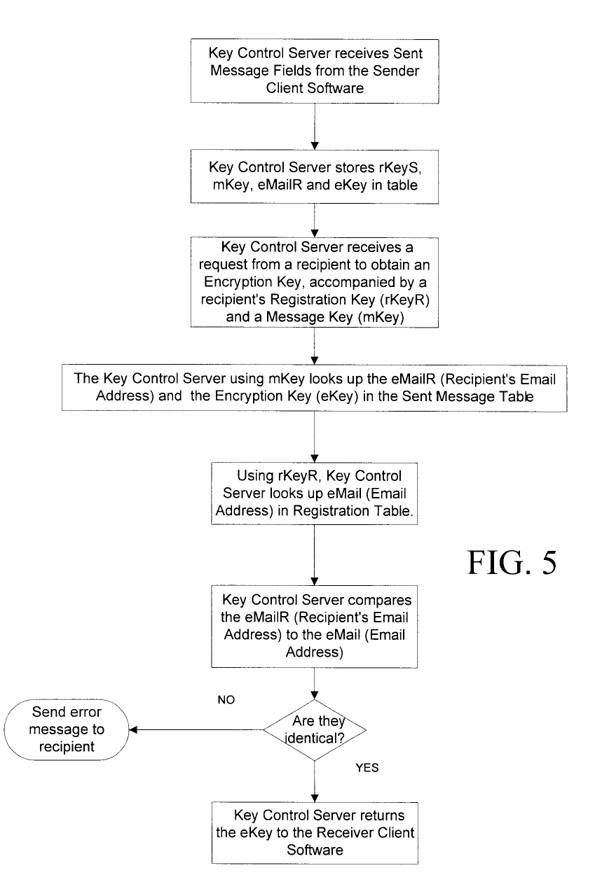

FIG. 5 illustrates the process by which the Key Control Server 16 relays the Encryption Key from the sender 10 to the recipient 14. When the Sender Client Software encrypts and sends the email, the Key Control Server 16 performs the following functions. The Key Control Server 16 receives Sent Message Fields from the Sender Client Software, namely, mKey, eMail^{R} and eKey, and optionally a rKey^{s}, across a secure link, such as SSL or TLS which are stored in table 20. The Key Control Server 16 may subsequently receive a request from a recipient 14 to obtain an Encryption Key, accompanied by a recipient's Registration Key (rKey^{R}) and a Message Key (mKey). The Key Control Server 16 verifies the recipient's Registration Key (rKey^{R}) and Message Key (mKey) by the following steps: a) Using mKey, it looks up the eMail^{R} (Recipient's Email Address) in the Sent Message Table. b) Using rKey^{R}, it looks up eMail (Email Address) in Registration Table. c) It compares the eMail^{R} (Recipient's Email Address) to the eMail (Email Address) and confirms that they are identical. If the comparison in c) results in an identical match, it looks up the Encryption Key (eKey) in the Sent Message Table 22 using the Message Key (mKey) to locate the correct record. It then returns the eKey to the Receiver Client Software across a secure link, such as SSL or TLS.

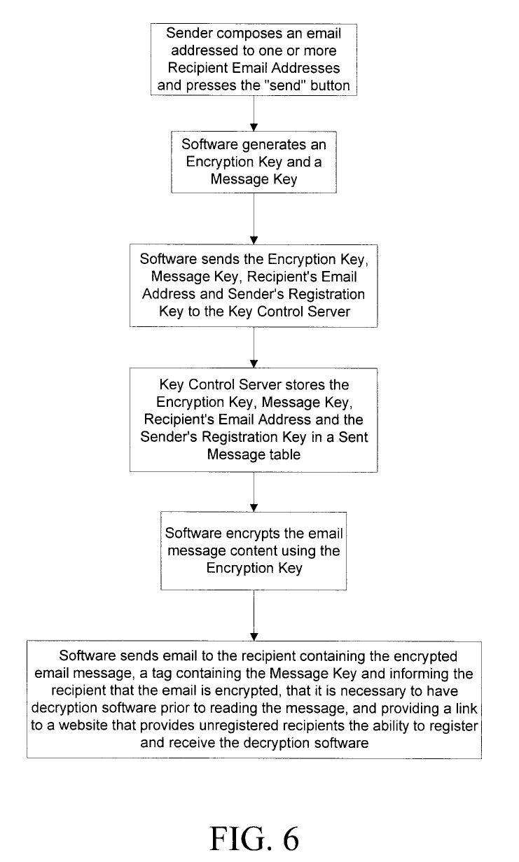

FIG. 6 illustrates the process by which a registered sender 10 sends an encrypted email using the present invention. Sender 10 composes an email addressed to one or more Recipient Email Addresses and presses the “send” button on his/her email client software. The “send” button on the email client software is modified to run the following processes prior to sending the email. Software resident on the sender's client computer 10 takes the email's body and attachments as input. The software generates an Encryption Key using a predetermined key-generating algorithm, such as a random number generator or other key-generating algorithm. The Encryption Key is a sequence of characters used by an encryption algorithm to encrypt the email contents. The software also generates a Message Key using a second predetermined key-generating algorithm, such as a sequential number. The Message Key is a unique value that identifies the specific message being sent. The software sends the Encryption Key, Message Key, Recipient's Email Address and optionally the Sender's Registration Key to the secure Key Control Server 16. Key Control Server 16 stores the Encryption Key, Message Key, Recipient's Email Address and optionally the Sender's Registration Key in a Sent Message table 20. The software also encrypts the email message content, using the Encryption Key and a Symmetrical Encryption process. The software sends an email to the recipient 14 containing the following: i) the encrypted contents of the email (including the encrypted email body and attachments); ii) a tag containing the Message Key; and iii) a text message in the body of the email informing the recipient that the contents of the email are encrypted, that it is necessary to have a registered copy of the decryption software prior to being able to read the encrypted contents using the system, and providing a link to a website that provides unregistered recipients the ability to register and receive a copy of the required software.

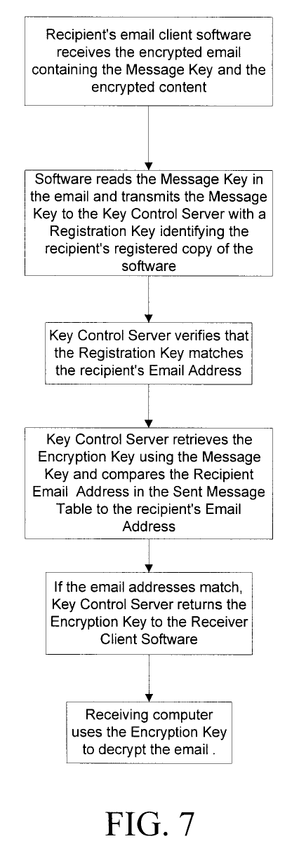

FIG. 7 illustrates the process by which a recipient 14 receives and decrypts an encrypted email. First the recipient email client software receives the encrypted email containing the Message Key and the encrypted content. The software reads the Message Key in the email. The software transmits the Message Key to the Key Control Server 16 with a Registration Key identifying the recipient's registered copy of the software. The Key Control Server 16 verifies that the Registration Key matches the recipient's Email Address, to ensure that the recipient is authorized to read the email. If recipient is authorized to read the email, the Key Control Server 16 retrieves the Encryption Key using the Message Key to locate the record in the database. The Key Control Server 16 responds to the recipient's client software by returning the Encryption Key used by the sending computer to encrypt the email. The receiving computer will use the Encryption Key corresponding to the Message Key to decrypt the email automatically.

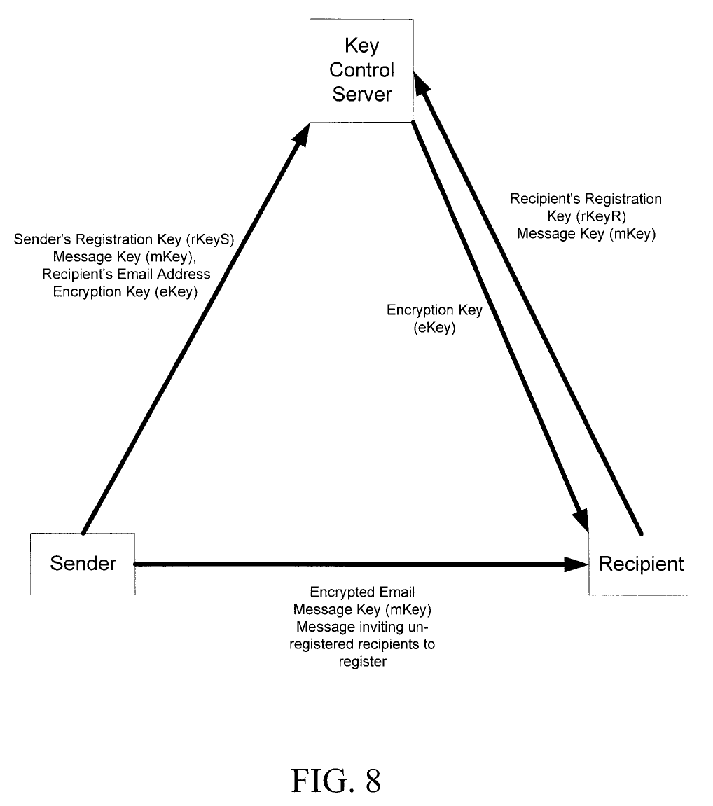

The following summary of the overall method of the invention is illustrated in FIG. 8. First, the sender 10 composes an email and “sends” the email to a recipient email address. The Sender Client Software generates the following fields (as well as the email itself):
a. Message Key (mKey),
b. Recipient's Email Address
c. Encryption Key (eKey)
and optionally
d. Sender's Registration Key (rKey^{s})

This information is sent to the Key Control Server 16 across a secure connection, such as HTTPS or TLS.

The email is encrypted using the Encryption Key by Symmetrical Cryptography. The Message Key (mKey) is inserted into the email body by the Sender Client Software, along with a message inviting un-registered recipients to register. The encrypted email is received by the Recipient Client Software. The email contains the mKey in its body.

The Recipient Client Software transmits the following fields to the Key Control Server: i) Recipient's Registration Key (rKey^{R}); and ii) Message Key (mKey). If the Key Control Server authorizes the recipient to decrypt the message, the Key Control Server returns the Encryption Key (eKey) to the Recipient Client Software. Using the eKey, the Recipient Client Software is able to decrypt the message using the same Symmetrical Cryptography protocol that the sender 10 used to encrypt the message.

This invention thus provides number of benefits over existing methods of email encryption. Encryption Keys are generated and exchanged seamlessly, without the Sender or the Recipient playing an active role. No prior key exchange process is required, unlike the process required in PKI encryption. The recipient does not need to be pre-registered and does not need to engage in a complex authentication process. Multiple recipients can read a single encrypted email. The system can certify users in a manner that provides ease of use while maintaining strict controls, and works seamlessly with the existing global email infrastructure.

When the Email Client Software is used by the Sender to send the same email to a list of intended recipients, e.g. alfred@mondotag.com, sandra@mondotag.com and morris@mondotag.com, the Email Client Software can send the Message Key, the Recipient Email Address and the same Encryption Key for everyone on the list to the Key Control Server for each intended recipient. Then the Sender's Client Software can encrypt the email with a single Encryption Key and everyone on the list can exchange his/her Registration Key along with the Message Key for the Encryption Key upon receipt. By contrast, Asymmetrical Cryptography (PKI) requires the email to be encrypted with a different Encryption Key combination, as the Public Keys for each of the intended recipients will be different. As a result, PKI encryption schemes for email applications result in a cumbersome process of having to re-encrypt and resend the message multiple times, once for each intended recipient.

The invention results in a new encryption key for every message, making the encryption virtually unbreakable. By contrast Public Key Encryption generally results in a static key. The probability of a hacker guessing a randomly generated Encryption Key is very low. The probability of a hacker matching the correct Message Key to the correct Registration Key for a given Recipient Email Address is lower. In other words, this key exchange process does not detract from the inherent security associated with Symmetrical Cryptography using dynamically assigned keys. Most key exchange processes by contrast have more vulnerability.

Additional benefits of the present invention are that the Message Key is not a function of the encrypted message file, as is the Encryption Key. So a system designed to decipher the message cannot derive any clues from the Message Key itself. The actual email message is not communicated to the Key Control Server 16, so the message takes a completely different path than the Encryption Key. This adds to the security of the process. This also means that the organization controlling the Key Control Server 16 does not have access to the email message, ensuring that the Key Control Server 16 is not a point of vulnerability.

Various additional features can be added to the system. Confirmation of delivery is made possible, because the Key Control Server 16 can be programmed to return a message to the sender's email client when the recipient's email client software has returned the Message Key and the Registration Key during the delivery of the Encryption Key. Since a recipient can only read the message when he/she makes the key exchange, this process will confirm that the message has been read in all cases in which the Encryption Key has been accessed. By contrast, the current state of the art allows for confirming an email's receipt in one of two ways. In one case, the sender can request a “Return Receipt” using the standard email protocol, but the end user can opt to “cancel” the “return receipt”, thus reading the email but not confirming receipt. In most cases, recipients press the “cancel” button and this function is thus rendered useless. Secondly, the sender can embed a cgi or url in the email message, in HTML format. When a recipient receives the message on an HTML-compatible email client, the system can return an HTML message to a server that records the receipt of the message. This type of system is offered by a number of companies, but suffers from a major flaw, namely that any email client software that does not support HTML (e.g. a Blackberry device or an email client with the HTML function turned off) will not return confirmation of receipt. Additionally, some email client software programs are equipped with tools to block this type of message.

In the present system, multiple recipients can have their individual receipt of the message confirmed to the sender, when sending a single email to a list of recipients. Current systems that use cgi's or url's insert a single HTML expression into the email body. When any user on the list of recipients reads the message, the same message is returned for each instance of the message. In other words, if an email is copied to alfred@mondotag.com, sandra@mondotag.com and morris@mondotag.com, all of these messages will have identical content in the HTML expression in the email body, e.g. http://www.cgiserver.com/messageID. When each of the three recipients opens their email, conventional cgi or url based systems will return the same “messageID” each time the message is opened. This gives the sender no way of knowing who opened the message.

By contrast, the system described in this invention captures the Message Key and Registration Key in each case. As each recipient will have a different Registration Key, the Key Control Server 16 will be able to record each instance that the message is read separately, attributing each “receipt” of the message to the appropriate user.

Confirmation of content is also made possible, as the system can also record a hash or “checksum value” at the time the message is sent and can reproduce this hash or checksum computation during the receipt process. This hash or checksum value can be confirmed by the Key Control Server 16 and provide the sender with proof that the message content was consistent with the content that produced a given hash value.

The Registration Key for each user is as secure as the user's computer. Users can add to the security of the Registration Key, by encrypting the Registration Key while not in use. In the unlikely event that a hacker gets access to a Registration Key, the key would be useless unless the hacker had access to a message containing a Message Key that related to the Email Address of the recipient. Additional security can be provided by making the Message Keys expire after a pre-determined period of time, thus making old messages unreadable. The Key Control Server 16 can be configured to delete records from the Sent Message Table 20 after a pre-determined time has elapsed. In the event that a single Registration Key is compromised, the integrity of the rest of the system remains intact for all other users of the system.

While a number of exemplary aspects and embodiments have been discussed above, those of skill in the art will recognize certain modifications, permutations, additions and sub-combinations thereof. While the system has been described wherein the sender's and recipient's email addresses are used as the unique user identifications, other unique user identifications can be used. It is therefore intended that the following appended claims and claims hereafter introduced are interpreted to include all such modifications, permutations, additions and sub-combinations as are within their true spirit and scope.

What is claimed is:

1. A method of sending an encrypted email communication from a sender to a recipient by using a key control server, wherein said recipient is registered with said key control server in association with a unique user identification, comprising the steps of:
i) said sender generating an encryption key and a message key which uniquely identifies said email communication;
ii) said sender communicating said encryption key, message key, and said recipient's user identification to said key control server;
iii) either before, after or concurrently with step ii) said sender encrypting said email communication with said encryption key and communicating said encrypted email communication and said message key to said recipient;
iv) said recipient, after receiving said encrypted email communication and message key from said sender, communicating said message key and said recipient's user identification to said key control server; and
v) said key control server comparing the recipient's user identification communicated by the sender in association with the message key to the recipient's user identification communicated by the recipient with said message key and if the two are the same, communicating said encryption key to said recipient.

2. The method of claim 1 wherein said recipient's user identification comprises said recipient's email address.

3. The method of claim 1 wherein said sender also communicates a sender's user identification to said key control server.

4. The method of claim 3 wherein said sender's user identification comprises said sender's email address.

5. The method of claim 1 wherein said encryption key is a one time pad.

6. The method of claim 1 wherein said encryption key is generated by said sender using a random number generator.

7. The method of claim 1 wherein said message key is generated as a sequential number.

8. The method of claim 1 wherein said message key forms part of said encrypted email communication.

9. The method of claim 1 wherein said email communication from said sender to said recipient includes a message instructing unregistered recipients how to register with the system.

10. The method of claim 9 wherein said email communication from said sender to said recipient includes a link to a registration website which permits unregistered recipients to register with the system.

11. A computer system for sending an encrypted email communication from a sender to a recipient over a computer network by using a key control server, wherein said recipient is registered with said key control server in association with a unique user identification, said system comprising:
i) a sender client computer comprising means for generating an encryption key and means for generating a message key which uniquely identifies said email communication, means for encrypting said email communication with said encryption key and communicating said encrypted email communication and said message key to said recipient;
ii) a key control server for receiving from said sender and storing said encryption key, said message key and said recipient's user identification;
iii) a recipient client computer comprising means for receiving said encrypted email communication and message key from said sender, means for communicating said message key and said recipient's user identification to said key control server, and means for receiving said encryption key from said key control server and decrypting said email message; and
v) said key control server further comprising means for comparing the recipient's user identification communicated by the sender in association with the message key to the recipient's user identification communicated by the recipient with said message key and if the two are the same, communicating said encryption key to said recipient.

12. The computer system of claim 11 wherein said recipient's user identification comprises said recipient's email address.

13. The computer system of claim 11 wherein said sender also is registered with said key control server in association with a unique user identification and said sender client computer comprises means for communicating said sender's user identification to said key control server.

14. The computer system of claim 13 wherein said sender's user identification comprises said sender's email address.

15. The computer system of claim 11 wherein said encryption key is a one time pad.

16. The computer system of claim 11 wherein said means for generating said encryption key comprises a random number generator.

17. The computer system of claim 11 wherein said message key is generated as a sequential number.

18. The computer system of claim 11 wherein said message key forms part of said encrypted email communication.

19. The computer system of claim 11 further comprising a registration website which permits unregistered recipients to register with the system.

20. A computer program product comprising a memory having stored there-in computer-executable instructions that when executed by a computer carry out the method of claim 1.
